(19) United States
(12) Patent Application Publication
(10) Pub. No.: US 2009/0150253 A1
(43) Pub. Date: Jun. 11, 2009

(54) SYSTEM AND METHOD FOR FACILITATING ADVERTISING

(76) Inventors: Phillip W. Williams, Plano, TX (US); Donald R. Hancock, Frisco, TX (US); Ronald R. Bandy, Plano, TX (US); Lane J. Segerstrom, McKinney, TX (US)

Correspondence Address: DeLeon Law Group PC, 100 Crescent Court, Suite 700, Dallas, TX, 75201, US

(21) Appl. No.: 12/246,287

(22) Filed: Oct. 6, 2008

Related U.S. Application Data
(60) Provisional application No. 60/978,049, filed on Oct. 5, 2007.

(51) Int. Cl. G06Q 30/00; G06Q 40/00; G06Q 90/00

(52) U.S. Cl. 705/26; 705/37

(57) ABSTRACT

An embodiment of the present invention includes a system and method effectively and efficiently facilitate the selling and buying of advertising online.

### CROSS-REFERENCE TO RELATED APPLICATION

Applicants claim priority based on provisional patent application Ser. No. 60/978,049; filed Oct. 5, 2007, the entire contents of which are incorporated herein by

### DETAILED DESCRIPTION OF THE INVENTION

For a more complete understanding of the present disclosure and its advantages, reference is now made to the following description taken in conjunction with the accompanying drawings, in which like reference numerals represent like parts:

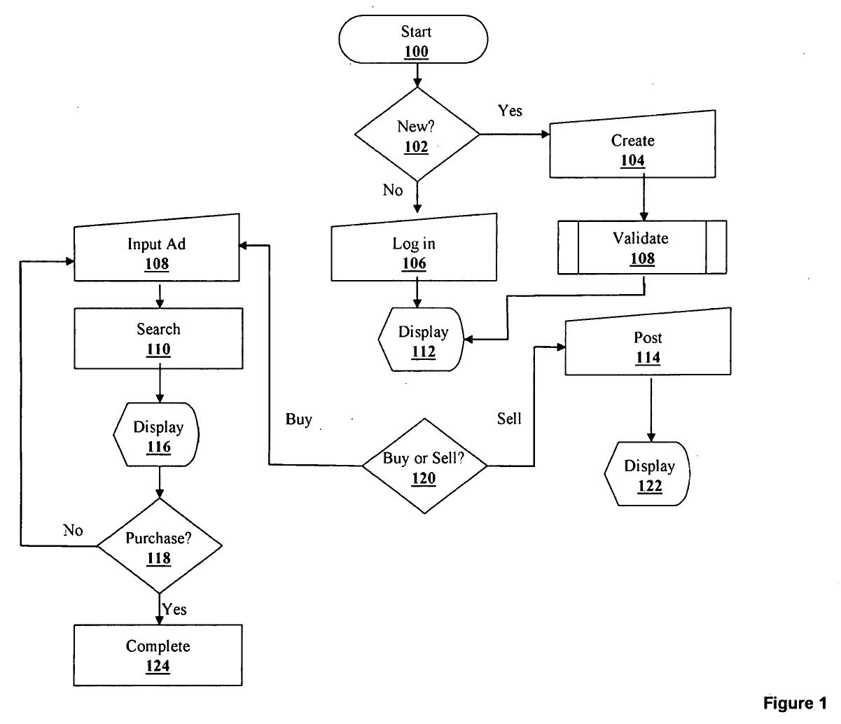

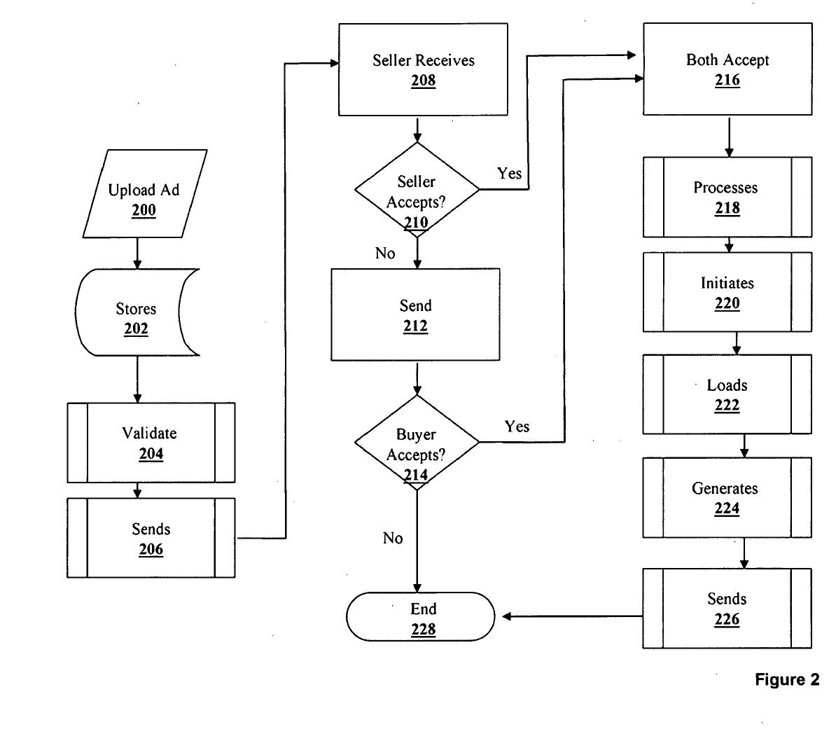

FIGS. 1 and 2 are flow diagrams of an embodiment of the present invention;

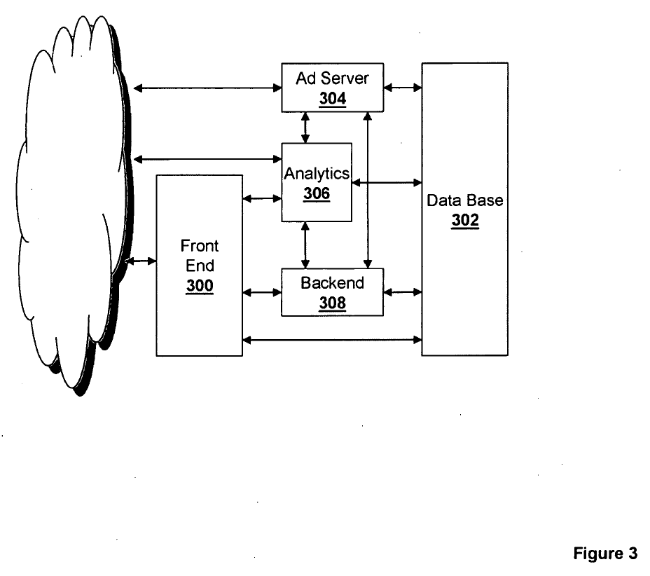

FIG. 3 is an example architecture of an embodiment of the present invention; and

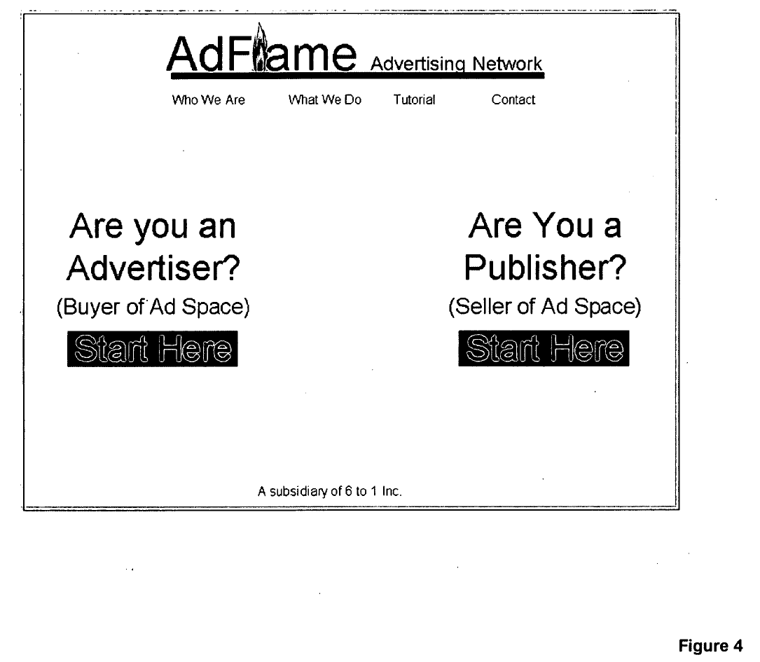

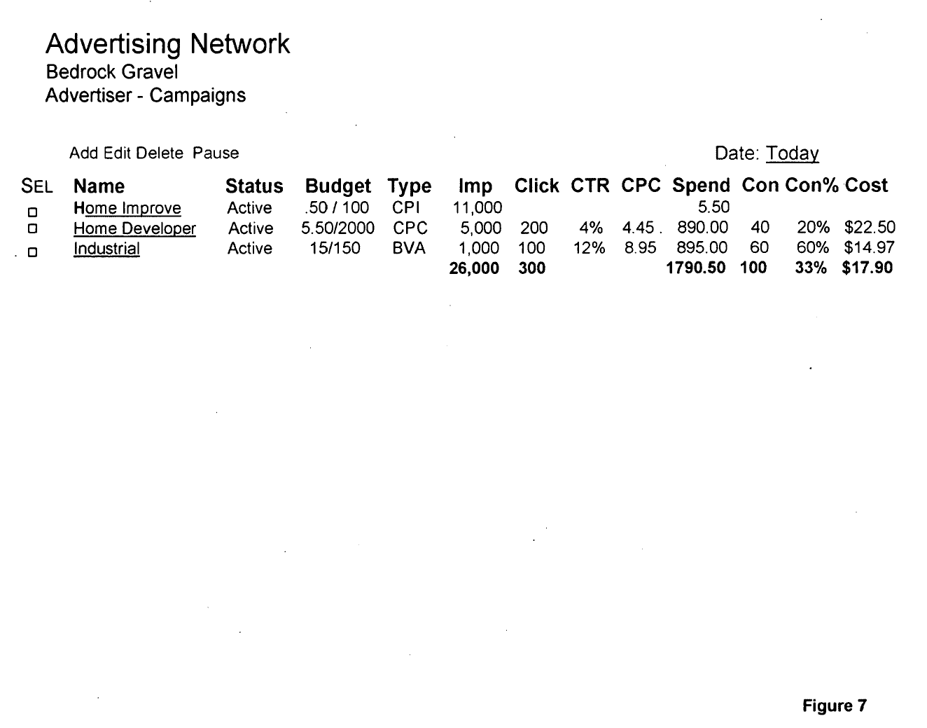

FIGS. 4-12 are example web pages.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown but is to be accorded the widest scope consistent with the principles and features disclosed herein.

The present invention relates generally to a system and method of facilitating the selling and purchasing of online advertising.

Advertising online has grown over the years. Most brick and mortar stores and companies now advertise online. However, a system does not exist that can efficiently and effectively facilitate the selling and buying of advertising online.

Therefore, a need exists for a system and method effectively and efficiently facilitate the selling and buying of advertising online.

An embodiment of the present invention includes a system and method effectively and efficiently facilitate the selling and buying of advertising online.

Introduction

Scope

The Advertising System (ASYS) is an online module designed for building an open market for any product or service. In its simplest form, ASYS acts as the broker to make a market in any commodity. However the software can support acting as the quasi exchange.

The purpose of this software is to provide a general platform for the buying and selling of any commodities or services.

A high level flow chart of ASYS' solution is shown in FIGS. 1 and 2. Figure shows that a start block 100 to then proceeds to the New Subscriber 102 decision. If a new subscriber, then the system proceeds to the create subscriber profile 104. The profile is then validated 108 and then the profile is displayed 112. If the subscriber is not new, the process then proceeds to log in 106. Once the subscriber is online, they can chose to buy or sell 120. If the subscriber wants to buy an ad, they input the ad criteria 108, the database is searched 110 and the search results are displayed 116. Then the system proceeds to see if the buyer wants to buy the ad space 118. If yes, then a purchase request form 124 is completed. If the buyer doesn't want to purchase the ad, they can either input other ad criteria 108 or quit looking for ads. If the subscriber wants to sell an ad, they first post the ad 114 and then the ad is displayed with the listings 122.

FIG. 2 begins with an ad to be placed being uploaded 200, the system then stores the data 202. The system then validates the ad specification 204 and sends an email to seller to reflect the new bid. The seller then receives an email with any bids on their ad and the bid is placed on their ASYS webpage 208. The seller can then accept/reject the bid or make a counter offer 210. If the seller accepts the bid 216, the system then processes payment 218, initiates 220 ad load on seller's website, then loads 222 audit utilities on the seller's website, generates an audit report for buyer and seller, and sends 226 a renewal invoice to both parties. If the seller makes a counter offer, the counter offer is sent 212 to the buyer. If the buyer rejects the counter offer, the process ends. However, if the buyer accepts the offer, the process then goes to the both accept block 216.

ASYS Unique Advertising Framework

Traditional advertising models have been driven by the Advertiser. The golden rule here is “He who has the gold, rules.” ASYS changes that model to an open market where Publishers have equal control in the process. ASYS is unique in its simplicity for non-sophisticated Internet advertisers or publishers, as well as those who are experienced in the industry.

System Description

Now referring to FIG. 3, functionally, the ASYS software suite is comprised of four (4) modules: a Front End, which is the user interface to the Web 2.0 application; a Data Base, based on MySQL; an ad server module which provide the ad placement on websites; and the backend module, which provides accounting and billing information.

The Front End module is the user interface. It is on the ASYS website. Both Advertisers and Publishers gain access to the system via this module. The website is dynamic in nature. To populate the webpage, information is drawn from the Back Office, Database, and Analytics modules.

The Landing Page is the introduction page to the Advertisers. In this embodiment, the design is uncluttered. FIG. 4 shows an example landing page.

Registration/Login Description

To access the ASYS website, all users register by filling out a profile. Advertisers to ASYS services also complete the registration form. For security purposes, this information is encrypted. In addition, this information is stored in a MySQL database. Moreover, the Primary Contact is the default administrator for the account in this embodiment. However, additional users can be also added. Each user has a unique ID which is tied to the Company Account.

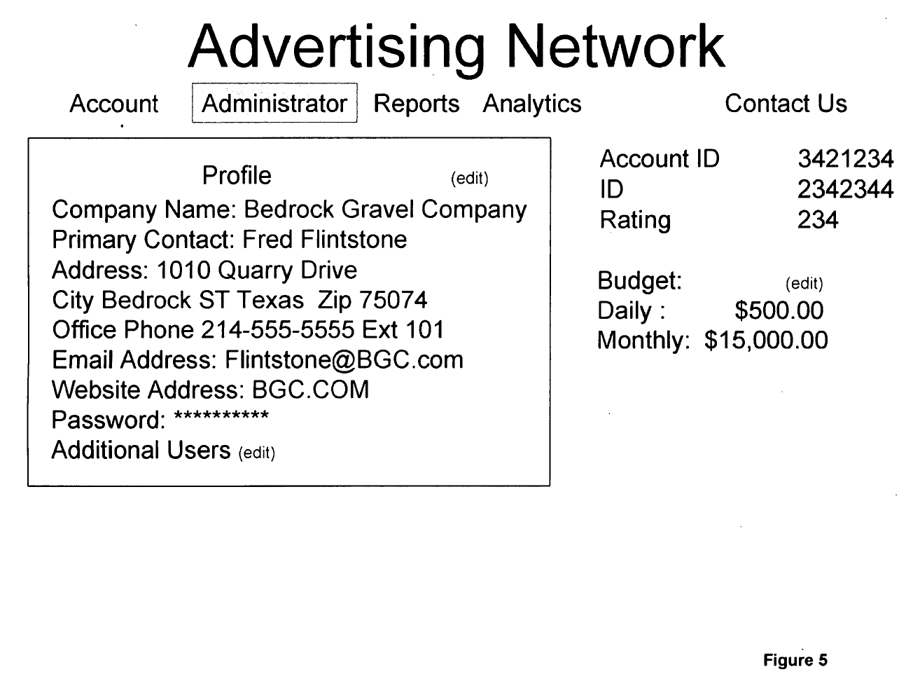

An example of an administrator's home page is shown in FIG. 5.

Further, security access is assigned at the user level at three levels: Full Admin Rights—users can have full administrative rights. Others have rights to Campaign Access, or View and Reports Only. Each user can have one or all access levels.

In this embodiment, this is the overall limit for an account. Companies can set a limit on the total spend for all campaigns for a given timeframe.

Based on the daily spend, the monthly will automatically be calculated.

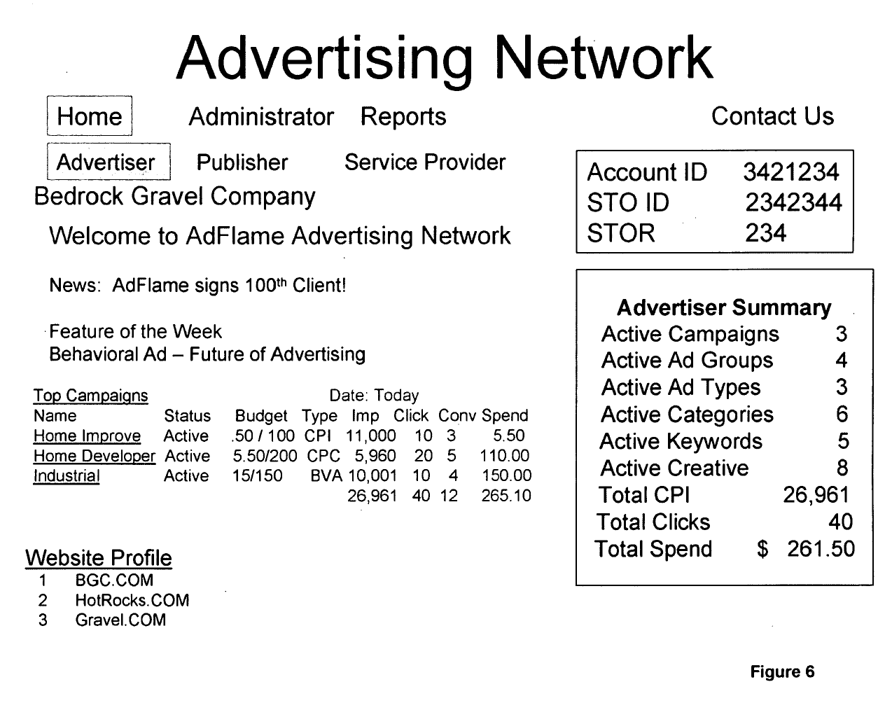

An example of Advertisers Home Page is shown in FIG. 6 Once an Advertiser has registered, he will be taken to Advertiser Home Page. The Advertiser Home page has the Advertiser's Company Name, Account ID, ID and rating. The Home page has an informational section showing the latest news articles supplied by RSS feeds. Information on the account status or status on the network are published in this section.

In addition, the Top Campaign section displays the current ad campaigns that are active with configurable columns to meet the Advertiser's requirements. Columns that are available include: Impressions, Clicks, Click %, Conversion, Conversion Rate, Cost Per Click, Cost Per Action, Total Spend. This information is held in the MySQL database. Original data is self-reported by the Publisher upon their registration. After placing ads with ASYS, the Ad server will collect usage information and populate Top Campaigns with the verified statistics.

Moreover, the Summary provides an overall view of active campaigns.

To place advertisements on the system, advertisers must identify the website and create a profile detailing their site description. The advertiser can create profiles for more than one site. Advertiser must identify which website for where the ad responses will be referred.

Advertiser—Campaigns

By clicking on Campaigns from the Advertiser—Home page, a complete list of all campaigns will appear. An example is shown in FIG. 6.

By clicking “Add” the Advertiser can add a new campaign by creating a ‘Name” for the new campaign. Example “Home Developer.”

Under the Advertiser—Campaign—Channels page, the Advertiser can click on the Channels tab to select all ad channels that apply to the campaign. Example Construction, Home Improvement, Industrial. Channels are groupings of Publisher's advertisements as it relates to the campaign.

Publisher

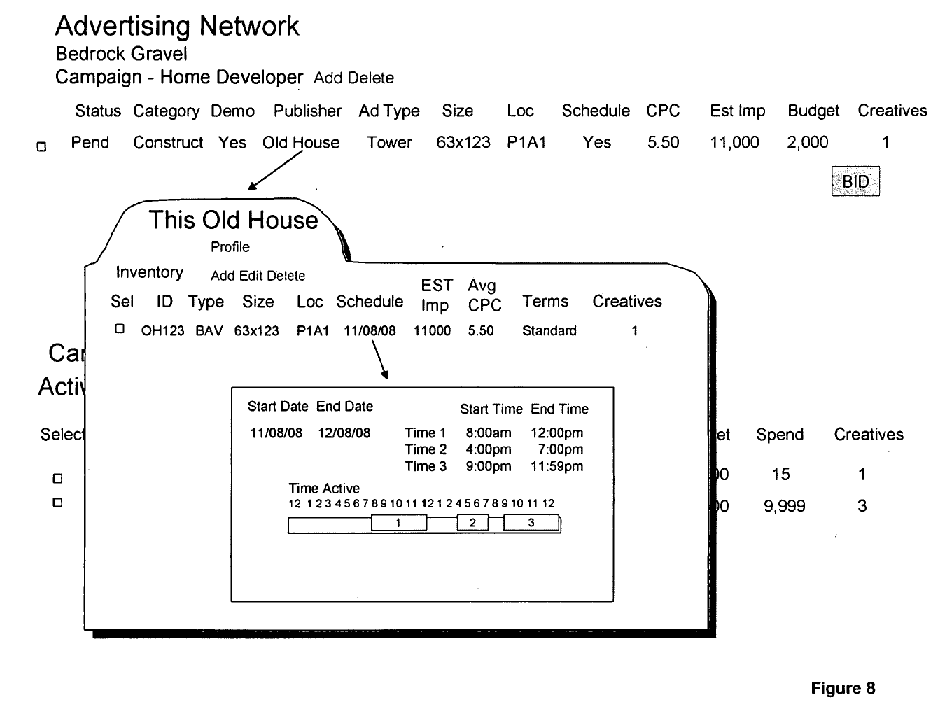

Clicking on a Publisher, Advertisers will be able to view a list of all publishers that have an ad in the “Construction” channel. Advertisers can then select from a list of all publishers who have inventory in the channel selected. This data is provided by the publisher when listing their ad space. See FIG. 8.

As, an example, the Advertiser selects “This Old House” as the publisher. A list of the inventory by that publisher will appear. The Advertiser can then select which advertisement space fits his needs. Ad Type, Size, Location.

Once an ad space is selected, the Advertiser can configure the schedule for the ad to run. The ad may have several variables depending on what the publisher will allow. Example, This publisher will allow up to three start/stop times per day for the ad to run.

Estimated Impressions

This is a historical estimate of how this ad space has performed. It is not a guarantee of future performance. It is tool for Advertisers to estimate how many views a page will receive on a daily basis.

Average Cost Per Click

This is the price the publisher charges for CPC based on the ad type, size, location, and schedule. By clicking on Terms, the Advertiser can view the Terms and Conditions of the publisher. The Advertiser must accept the Terms to continue with the transaction.

Creative's

By clicking on Creative's, the Advertiser can upload ads and view them as they will appear on the publisher's website.

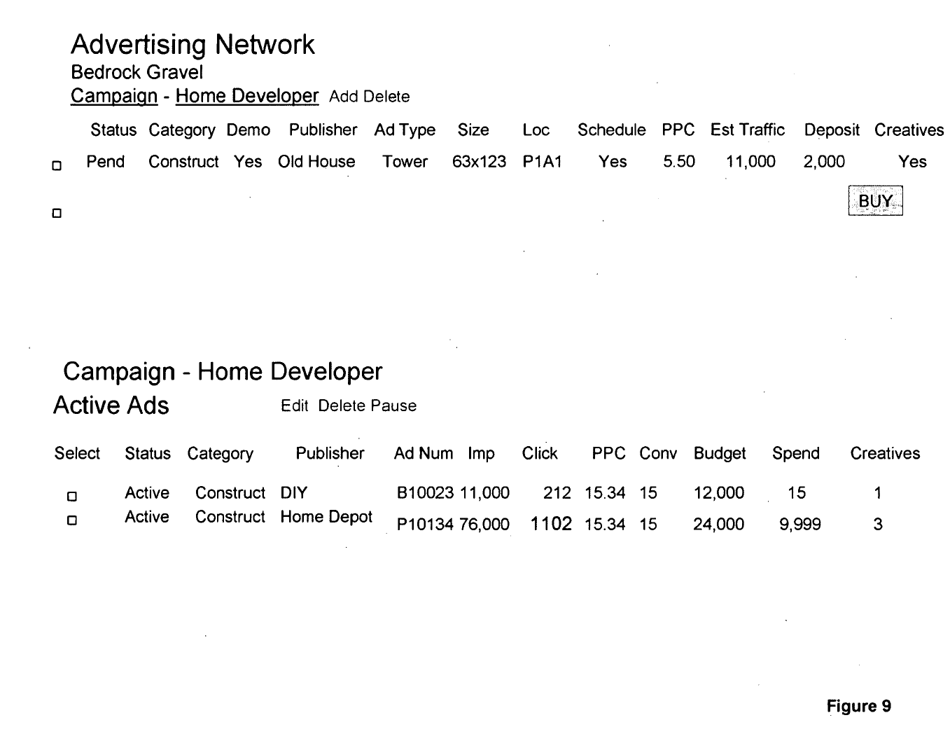

Based on the publisher's terms, the Advertiser will be able to load multiple ads to be displayed as shown in FIG. 9. The Advertiser defines the frequency of the ad rotation.

Once the ad is created, the Campaign-Home Developer screen will show the status of the new ad as “NEW”.

From this screen the Advertiser can select Budget to view estimated traffic based on the schedule. It will also allow setting the dollar amount for Click Thru on a daily or monthly budget for this ad.

The Advertiser can create other ads and review all ads and if ready to purchase, selects Bi.

Advertisement Approval Process

On submitting the bid, the publisher is notified of a transaction via email. The publisher's account will be updated to show transaction pending for his review.

The publisher must approve the ad “Creative” before transaction is complete.

The publisher has 24 hours to respond before transaction is withdrawn.

While the transaction is awaiting approval, the Advertiser's system will show the status as “Pending”.

Once approved by Publisher, the Advertiser's system will show status as “Approved”.

Publisher Home Page

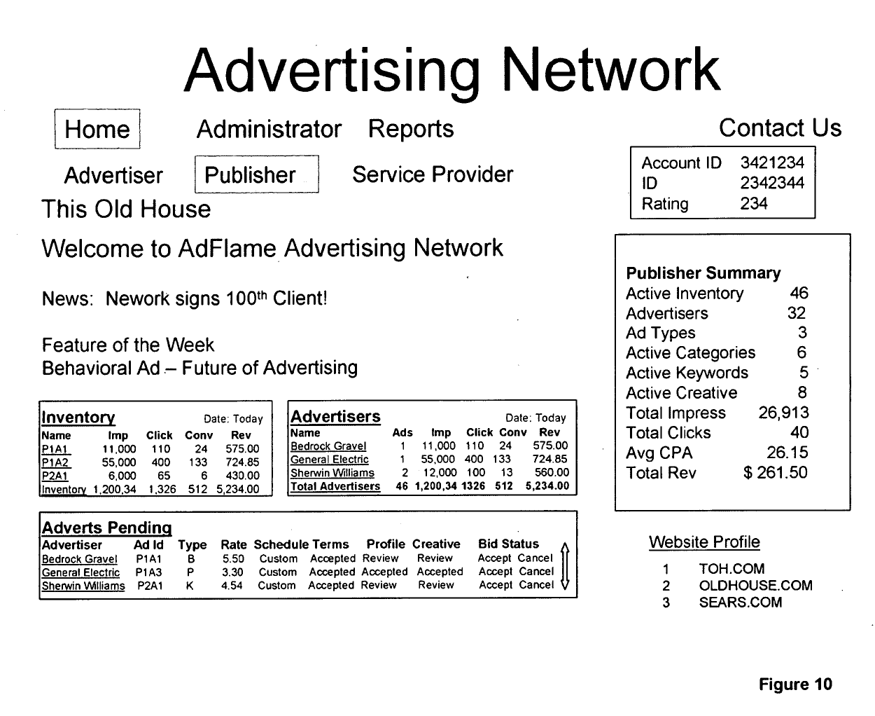

Once a Publisher has registered, He will be taken to Publisher Home Page—an example is shown in FIG. 10.

The Publisher Home page has the Publisher's Company Name, Account ID, ID and rating.

News

The Home page has informational section showing latest news articles supplied by RSS feeds. Information on the account status or status on network is published in this section.

Publisher Inventory

The Inventory section displays the current Top 5 Ad Spaces with configurable columns to meet the Advertiser requirements. Columns that are available are: Impressions, Clicks, Click %, Conversion, Conversion Rate, Cost Per Click, Cost Per Action, Total Revenue. This information is held in the MySQL database. Original data is self reported by Publisher on their registration. After placing ads with ASYS, the Ad server will collect usage information and populate with the verified statistics.

By clicking on Inventory, the full ad inventory will be displayed.

Publishers can Add, Edit, Delete, Pause the ad space from the inventory.

Publishers Summary

The Publisher section displays the current Top 5 Advertisers on the Publisher's website with configurable columns to meet the Publishers' requirements. Columns that are available are: Impressions, Clicks, Click %, Conversion, Conversion Rate, Cost Per Click, Cost Per Action, Total Revenue. This information is held in the MySQL database. After placing ad space with ASYS, the Ad server will collect usage information and populate with the verified statistics.

Publisher Summary

Provides an overall summary of the Publisher's inventory.

Advertisement Pending

The Advert Pending section displays a list of pending advertisement offers from Advertisers. The Publisher must review and accept or reject Advertisers' requests within 24 hours or the advert request will be automatically withdrawn.

Website Profile

To place advertisements on the system, Publishers must identify their website and create a profile detailing their site description. The Publisher can create profiles for more than one site. A Publisher must identify the website on which the ad will be placed and the address to which responses will be referred.

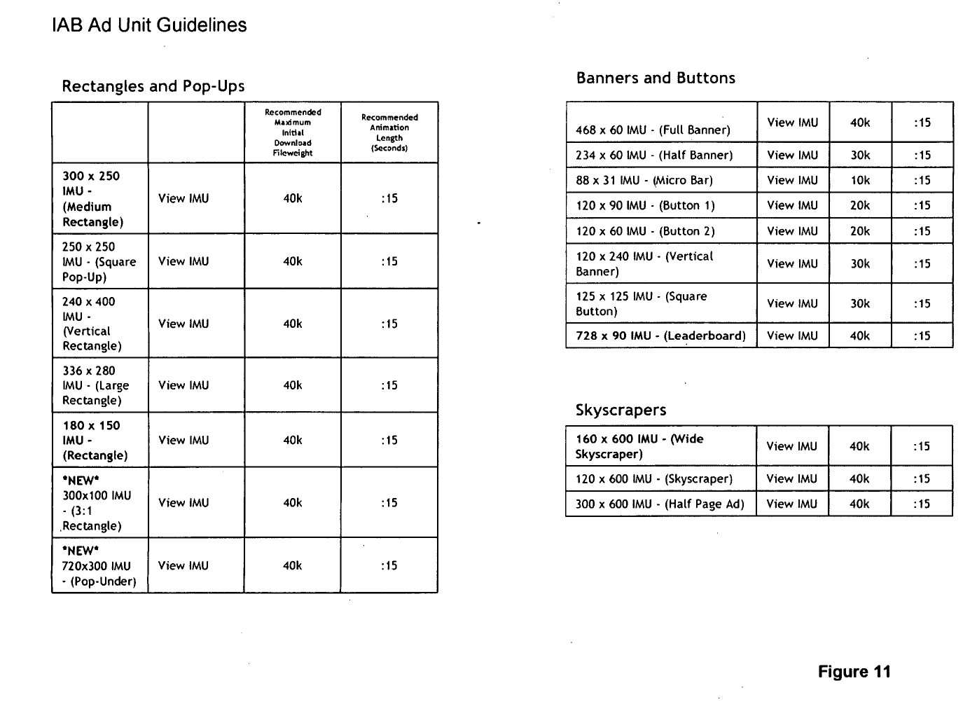

Publisher—Inventory—Zones are generally shown in FIG. 11.

A “Zone” is a specific place on the Publisher's website where ad will appear. To add a zone, the Publisher clicks “Add new zone.” In the Add new zone form, he must enter the requested information.

The zone must have a unique name. If the publisher does not enter a value in the Name field, ASYS names it as the name of the Publisher and “−Default”.

In the Description field the Publisher can enter information to make it easier to see what the zone is used for; e.g. Full banner (468×60).

Select a zone type.

Except for text ad zones, the publisher must specify the zone size and only banners that fit in those dimensions are displayed in the zone. The Size menu includes all the standard dimensions, defined by the IAB.

To display a banner which is not a standard size, the publisher can select the Custom size option at the bottom of the Size menu, and enter values in the Width and Height fields underneath. The publisher can enter specific values or can use a wildcard (‘*’). For example, a 120×* zone indicates that all banners with a width of 120, and of any height can link to this zone.

Zone Type

ASYS supports a wide range of zone types. When the Advertiser creates a zone, the Advertiser selects the type of zone he wants and this selection influences the types of zone invocation tags he can create to place in his web pages. This page describes the zone types and the tags they support.

A zone type can be one of the following types:

Banner, button or rectangle zones display banners as part of the content of the website and are the most standard zone type. With banner zones, you can choose any of the zone tag options.

Interstitial or Floating DHTML zones are for ads such as splash pages or ads that overlay on top of a web page which appear to “float”. JavaScript is the only type of tag for these zones. Four options are available for this type of zone:

The Simple option creates a zone for a splash page that appears on top of a web page and is typically set to disappear after a set period of time.

The Floater option creates a zone for an ad that moves across a web page to disappear at the far side or to loop across more often or continually.

The Cursor option creates a zone for an ad that appears by the user's mouse cursor and follows the cursor as it moves.

The Geocities option creates a zone for an ad that is similar to the ads that appear on Geocities pages. These banners appear at the top of a web page and the user can collapse and close them.

Popup zones show banners in a separate window that can appear either above or below (pop-under) the browser window. JavaScript is the only tag type available for these zones.

Text ad zones display text ads and can use JavaScript, Local Mode or XML-RPC tags.

Email/Newsletter zones display banners in HTML emails and the No Cookie Image tag is the only ad tag you can use.

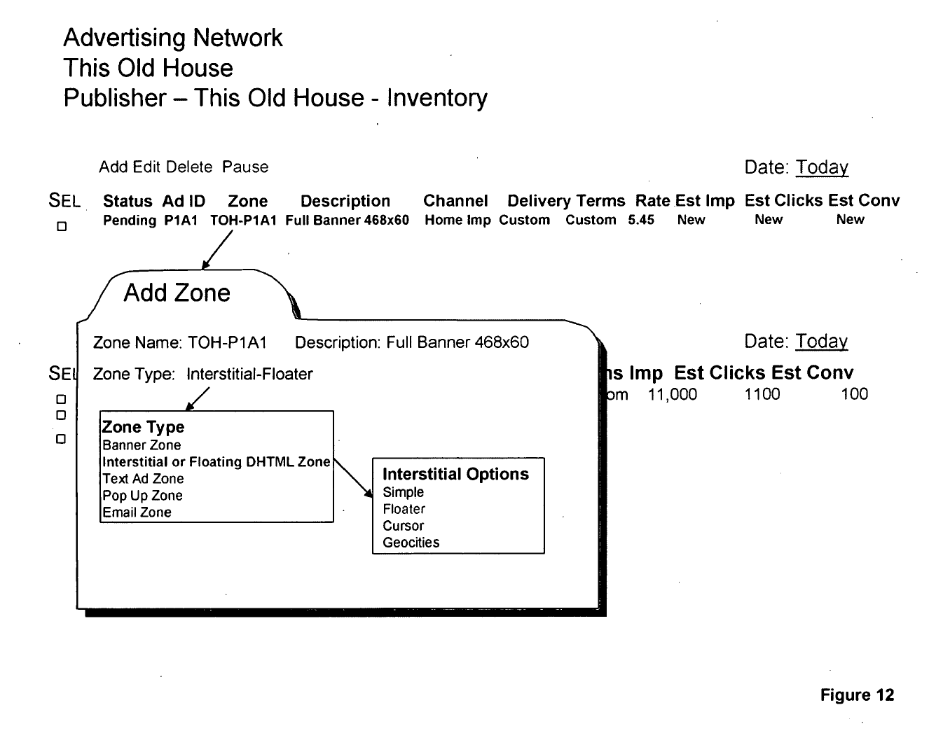

When the Publisher finishes defining the zone, he clicks the “Save Changes” button. ASYS opens the Advanced page, where you can specify additional properties for the zone as show in FIG. 12.

Advanced Zone Properties

In the Advanced tab of the Zone tab, a subscriber can set the following properties:

Delivery capping of zones

Subscribers can place a cap (or limit) on the number of times a visitor sees a zone. Subscribers can cap zones in two ways:

To cap the total number of times a visitor sees the banners linked to this zone, enter the number in the Limit zone views to: total field.

To cap the number of times a visitor sees banners in this zone in a single session, enter the number in the Limit zone views to: per session field.

ASYS records the number of views in cookies and subscribers can reset the cookie after a specified period by setting it in the Reset view counters after: field. If a visitor has disabled cookies, banners in capped zones will not be delivered to that viewer. If a visitor deletes existing cookies, the cookie is reset to zero and the visitor will see banners in this zone until the limits are again reached.

Zone Append

Subscribers can generate additional HTML when a banner is delivered for a zone, for example to show another form of banner, such as a pop-up. This code is executed each time a banner from this zone is delivered. Subscribers can enter their own HTML code or paste code from a supported ad network.

If subscriber sets the “Append even if no banner is delivered” option to ‘Yes’, the additional code is delivered even when no banner is delivered.

Zone Tags

The tag types are:

The JavaScript Tag—includes a no-script option for the very small number of users that are not JavaScript-enabled.

The Local Mode Tag enables server-side processing for banners that are stored locally, for example to change the site template when a user clicks on an ad. This tag works only when ASYS and your banners are stored on the same machine with the same top level domain. The website must be written in PHP or be able to parse PHP.

The XML-RPC Tag is similar to a local-mode tag but can be used for ads stored on a remote server.

The iFrame Tag uses the HTML iFrame tag to embed an advert in an iFrame on a web page.

The Image Tag—display banners to an audience that does not support JavaScript. Width and height attributes are not defined in this tag. If selected the Advertiser must allocate space for an ad before it shows, he must add this information directly into the tag.

The No Cookie Image Tag is an image tag which does not use cookies and is used by email zone types, because most email servers do not support the use of cookies.

When the Advertiser selects the tag type, he can set various optional parameters which change the Banner code for his zone. These parameters vary depending on the type of zone and the type of zone tag he use.

The following table describes these parameters and which tags use them.

| | | Used by which |
|---|---|---|
| Parameter | Description | tag types? |
| Target frame | This value sets the HTML TARGET attribute in the | All |
| | banner code. | |
| Source | Enter a source value if you want to limit banner delivery | All |
| | based on source, such as sports or news. | |
| Support 3rd party | Use this setting to track clicks in ASYS for ads served on | All |
| server click tracking | an external ad server. | |
| Insert cache-busting | JavaScript tags automatically insert a random number into | All |
| code | the invocation code to ensure that an earlier banner is not | |
| | delivered from the browser cache. With all other tags, to | |
| | avoid ad caching, manually enter into the tag | |
| Include comments | Removing comments from the banner code reduces the | All |
| | amount of code in your web pages. Review them carefully | |
| | before removing them because they contain information | |
| | about the code. After you have set all optional parameters, | |
| | you can then Click No to remove them. | |
| Show text below | Click Yes if you want to display text below a banner. | JavaScript, |
| banner | Enter this text in the Banner page. | Local mode, |
| | | XML-RPC |
| Don′t show the | Click Yes if you do not want to show the banner again on | JavaScript, |
| banner again on the | this page view. | Local mode, |
| same page. | | XML-RPC |
| Don′t show a banner | Click Yes if you do not want to show any other banner | JavaScript, |
| from the same | from this campaign on this page view. | Local mode, |
| campaign again on | | XML-RPC |
| the same page. | | |
| Store the banner | This option enables you to use local mode to display | Local mode |
| inside a variable so it | banners in site templates. If you Click No and use a site | |
| can be used in a | template, the banner will display before the rest of the | |
| template | page loads. | |
| Host language | PHP must be running on the remote host. | XML-RPC |
| Use HTTPS to | Click Yes if you want to connect to a secure server using | XML-RPC |
| contact XML-RPC | HTTPS. | |
| Server | | |
| XML-RPC timeout | Set the number of seconds to wait for a response from the | XML-RPC |
| (seconds) | server. | |
| Refresh after | To automatically refresh a banner, specify the number of | iFrame |
| | seconds between each reload. After each refresh, a new | |
| | banner from your zone is displayed. | |
| Resize iframe to | This option is only available if your website and ASYS | iFrame |
| banner dimensions | are on the same top level domain. In this case, it is | |
| | possible to show banners of different sizes in a zone and | |
| | the iFrame will resize to fit. | |
| Make the iframe | This option works only with Internet Explorer 5.5 or | iFrame |
| transparent | higher. | |
| Include Netscape 4 | Because the Netscape 4 ilayer does not work well with | iFrame |
| compatible ilayer | tables, do not place the banner in a table cell if you are | |
| | using this option. | |
| Include code to track | Click No if you do not want to track these clicks. | iFrame |
| Google AdSense | | |
| clicks | | |

Invocation Tag

After setting up a zone, the publisher selects the Invocation code tag. ASYS automatically generates an ad tag to paste into HTML pages which invokes (calls) ASYS's ad server to deliver ads. The types of tags available depend on the type of zone the Advertiser sets.

Channels

Channels are a way of defining different content sections of a website and applying a separate set of delivery options for each channel. Channels are useful when advertisers want to target specific visitor interests, for example home improvement or news.

To create a channel, the publisher clicks on the Publisher Channels overview tab and clicks the Add new channel.

In the Name field, the publisher enters a name for the channel, for example “Home Improvement”. The publisher can also add a Description and Comments for the channel.

When the publisher clicks Save Changes, the Delivery options page displays where the publisher can specify delivery options for the channel.

Delivery

To set delivery options, in the Publisher—Delivery tab, the Advertiser can select the options he wants from the drop-down menu. ASYS can limit banner delivery based on:

Site

Geography

Time

Client

Targeting by Site

The Advertiser can target ads based on the visitor website in a number of ways:

Target by Page URL to show the ad to visitors to one specific page.

Target by Referrer URL to show an ad to all visitors who came from the same referring page (for example, because the page has a hyperlink to the ad request page.

Target by Channel (or section) of a website. You must set up at least one channel to be able to use this targeting option.

Target by Variable to deliver an ad to any page request that contains a specified variable.

Geo-Targeting

With geo-targeting, the Advertiser can target ads to visitors from a specific location. Geo-targeting uses a 3rd party GeoIP database. ASYS can check the IP address of a visitor against this database to determine the visitor's location.

Targeting by Time

Traffic patterns to the Advertiser's website probably vary a lot depending on the hour of the day and day of the week. Advertisers can use delivery limitations to:

Target an ad to appear on a specific day or days, for example for a special promotion.

Target an ad to appear at particular hours in a day when their visitors are more likely to respond to an ad, for example to advertise a breakfast cereal early in the morning.

Target an ad to appear on a specific day, or days of the week, for example to advertise an entertainment venue on the days of regular events.

Targeting by Client

When a visitor requests an ad, information about the visitor's client is passed with the request. Advertisers can use this information to:

Target an ad to visitors in their own language, making it possible to serve different language versions of an ad for localized websites.

Target an ad to a specific domain, for example you could have one ad for visitors from the New York Times and another ad for visitors from Fox News.

Target an ad based on the IP address of the visitor. Blocks of IP addresses are assigned to ISPs and you can specify a range of IP addresses to target an ad to customers of a specific ISP.

Target by user agent, for example to show different versions of an ad for different browsers or operating systems.

After the publisher creates a set of options for the channel, it becomes available for selection when setting banner delivery limitations. To apply to a banner, the Advertiser selects the Site—Channels option in the delivery options section for the banner and then selects the relevant channel from the list of available channels. All options the Advertiser sets for the channel are then applied to the banner.

When creating the tag for a zone to add to the Advertiser's web pages, the Advertiser must enter the same value in the Source field as the name of the channel, for example “Home Improvement”.

Banner Capping

The Advertiser can place a cap (or limit) on the number of times a visitor sees a banner, campaign or zone. Advertisers can cap banners in two ways:

To cap the total number of times a visitor see a banner, enter the number in the Limit banner views to: total field.

To cap the number of times a visitor sees a banner in a single session, enter the number in the Limit banner views to: per session field.

ASYS records the number of views in cookies and Advertisers can reset the views total after a specified period by setting the period in the Reset view counters after: field. If a visitor has disabled cookies, capped banners will not be delivered to that viewer. If a visitor deletes existing cookies, capping information is reset to zero and the visitor will continue to see the banner until the limits are again reached.

Analytics

ASYS provides a wide range of statistics to help advertisers and publishers understand the effectiveness of advertising campaigns and where ads are placed on websites. Statistics are gathered each time the maintenance script runs.

Select the Home Page select the Analytics tab to view statistics for various periods (the default is for the current day), or you can select the Specify dates option and enter dates in the date fields. There are three overviews of statistics:

The Advertiser can view statistics for a specific campaign by clicking on the campaign. The Advertiser can now view the following statistics for the campaign for the selected period:

The Campaign history tab shows general statistics for the campaign and includes links to Create a Graph of Statistics and Export Statistics to Excel.

The Creative overview tab shows statistics for each creative in the campaign.

The Targeting statistics tab shows the zone forecasting and impressions delivered for this campaign.

The Creative history tab shows statistics for the banner and includes to links to Create a Graph of Statistics and Export Statistics to Excel.

In the View by menu you can select to aggregate statistics by:

Day

Week

Month

Day of the month

Hour

Publisher Analytics

When the Publisher click the Publisher—Analytics tab, ASYS displays the statistics for the publishers, for the time period already set in this menu. Change the date period to view statistics for another period, such as last week or month.

Expand details of a publisher to view campaign statistics for a zone. You can view the following statistics for the campaign for the selected period:

The Zone history tab shows general statistics for the zone and includes links to Create a Graph of Statistics and Export Statistics to Excel.

The Campaign distribution tab shows what campaigns and banners were delivered in this zone.

In the View by menu you can select to aggregate statistics by:

Day

Week

Month

Day of the Month

Hour

For both the advertiser and publisher, they can view the following:

Impressions

Clicks

Conversions

CTR (click through ratio)

Revenue

Reports

From the Home Page, the Advertiser can click on the Reports tab to generate a range of reports which he can then download in Excel file format. The following reports are:

Advertising Analysis Report

Campaign Analysis Report

Conversion Tracking Report

Campaign Delivery Report

To create a report, the Advertiser clicks on the link for the relevant report and then:

Select the Period to include in the report, such as Today, This month or All Statistics from the drop-down menu. If you select Specific dates from the menu, enter these in the date fields.

Select the Limitations, such as for a particular advertiser, publisher or campaign. The Advertiser selects the Worksheets he wants to create. Each report type has a number of standard worksheets that provide various views of the activity on their system.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method effectively and efficiently facilitate the selling and buying of advertising online, the method comprising:
posting a price by a seller for selling of at least one space for advertisements;
uploading an advertisement by a buyer;
bidding by a buyer on placing an advertisement on the at least one space;
determining if seller accepts or rejects the bid by the buyer for placing an advertisement; and
if seller accepts the bid, then, processing payment, and placement of the advertisement on the at least one space.

2. The method of claim 1 wherein if the seller rejects the bid by the buyer, sending a counter offer to the buyer.
